(19) United States
(12) Patent Application Publication
(10) Pub. No.: US 2016/0353023 A1
(43) Pub. Date: Dec. 1, 2016

(54) MINI REMOTE MULTI-CONTROL UNIT

(71) Applicant: Jung Suk LEE, Busan (KR)

(72) Inventor: Jung Suk LEE, Busan (KR)

(21) Appl. No.: 14/727,405

(22) Filed: Jun. 1, 2015

(51) Int. Cl. H04N 5/232; H04N 17/00; H04N 7/18

(52) U.S. Cl. CPC H04N 5/23241; H04N 5/23203; H04N 7/183; H04N 17/002

(57) ABSTRACT

A mini remote multi control unit is disclosed. The mini remote multi control unit features a controlled device located at a distance and capable of detecting the malfunctioning controlled device, resetting and restoring it to its original state. The mini remote multi control unit includes a power supply unit receiving power from an outside source, featuring more than one power terminal block and producing power to more than one controlled device connected to any of the power terminal blocks, a communication part transmitting and receiving power control data to power on/off controlled devices and the power terminal blocks, and a control part selectively turning off any of the power terminal blocks on the power supply unit and then turning it back on to reset a controlled device if the controlled device is deemed as malfunctioning by using power control data transmitted from the communication part.

### BACKGROUND OF THE INVENTION

Technical Field

The present invention relates to a mini remote multi control unit. More specifically, the invention relates to a mini remote multi control unit featuring a controlled device located at a distance and capable of detecting the malfunctioning controlled device, resetting and restoring it to its original state.

Background Art

Devices that require power are energized using on/off switches on-site. Home appliances used in homes can be operated using remote controls, but remote controls have limited range and do not work outside their specified range.

In some cases, it is necessary to control power supply, data storage, data communications, and system updates from a distance. For instance, in places where speed and traffic enforcement cameras or security cameras are installed, if any problems arise with surveillance or enforcement operations, an operator generally has to open up a box on a pole in which the camera is installed and shut off the computer to control the device. In such a case, since the operator must be working near the camera and make rounds for law enforcement, it involves a waste of human resources.

Meanwhile, under the site conditions where operators should not be working on cameras, those cameras can be turned on/off using remote networks, but they may not be controlled properly as it is difficult to identify site problems from a distance.

### SUMMARY OF THE INVENTION

### Technical Problem

It is therefore an object of the present invention to solve the aforementioned problem by providing a mini remote multi-control unit which can control the power supplies of devices from a distance, in order to prevent maintenance/repair costs caused by using manpower, since the malfunctioning of devices at industrial sites is usually solved by turning off their power switches, or by resetting the devices.

It is also an object of the present invention to provide a mini remote multi-control unit which can accurately analyze the presence of malfunction, while controlling the power of a camera, computer and router in an electronic box where controlled devices, particularly surveillance or enforcement camera systems, are installed.

It is also an object of the present invention to provide a mini remote multi-control unit which can quickly issue alarms to a control room when recurring malfunctions occur in controlled devices.

It is also an object of the present invention to provide a mini remote multi-control unit which can relay communication between controlled devices to facilitate data communication between controlled devices.

The technical objects of the present invention are not limited to those described above, and it will be apparent to those of ordinary skill in the art from the following description that the present invention includes other technical objects not specifically mentioned herein.

### Solution to Problem

A mini remote multi-control unit of the present invention comprises a power supply unit which receives power from an outside source, features more than one power terminal block and produces power to more than one controlled device connected to any of the power terminal blocks; a communication part which transmits and receives power control data to power on/off controlled devices and the power terminal blocks; a control part which selectively turns off any of the power terminal blocks on the power supply unit and then turns it back on to reset a controlled device if the controlled device is deemed as malfunctioning, using power control data being transmitted from the communication part.

In addition, a characteristic of the control part of the present invention is that it can cause a power terminal block to be turned off and then turned back on after a period of time.

### Beneficial Effects

According to the solution to the technical problem, the mini remote multi control unit of the present invention can control the power supplies of devices from a distance in order to prevent maintenance/repair costs caused by using manpower, since the malfunctioning of devices at industrial sites is usually solved by turning off their power switches, or by resetting the devices.

In addition, the mini remote multi control unit of the invention can accurately analyze the presence of malfunction, while controlling the power of a camera, computer and router in an electronic box where controlled devices, particularly surveillance or enforcement camera systems, are installed.

Furthermore, the mini remote multi control unit of the invention can quickly issue alarms to a control room when recurring malfunctions occur in controlled devices.

Moreover, the mini remote multi control unit of the invention can relay communication between controlled devices to facilitate data communication between controlled devices.

### BRIEF DESCRIPTION OF THE DRAWINGS

FIG. 1 is a top view of the mini remote multi control unit in a preferred embodiment of the present invention.

FIG. 2 is a side elevation of the power supply unit of the mini remote multi control unit in a preferred embodiment of the invention.

FIG. 3 is a side elevation of the communication part of the mini remote multi control unit in a preferred embodiment of the invention.

FIG. 4 is a block diagram that outlines the mini remote multi control unit in a preferred embodiment of the invention.

FIG. 5 is a drawing for operating a camera through traffic analysis of the mini remote multi control unit in a preferred embodiment of the invention.

FIG. 6 is a drawing for controlling a camera through image analysis of the mini remote multi control unit in a preferred embodiment of the invention.

FIG. 7 is a drawing for operating a computer through serial data analysis of the mini remote multi control unit in a preferred embodiment of the invention.

FIG. 8 is a drawing for controlling a computer through ping test analysis of the mini remote multi control unit in a preferred embodiment of the invention.

FIG. 9 is a drawing that illustrates the overload detecting operation of the mini remote multi control unit in a preferred embodiment of the invention.

### DETAILED DESCRIPTION OF THE PREFERRED EMBODIMENTS

### Best Mode for Carrying Out the Invention

The following best modes for carrying out the invention and drawings include the detailed description of the technical problem, the solution to that problem, and the beneficial effects of the invention. Further features and advantages of this invention, and the method of achieving them, will become apparent from the detailed description of preferred embodiments of the invention along with the attached drawings.

The following is the detailed description of the invention by referring to the attached drawings.

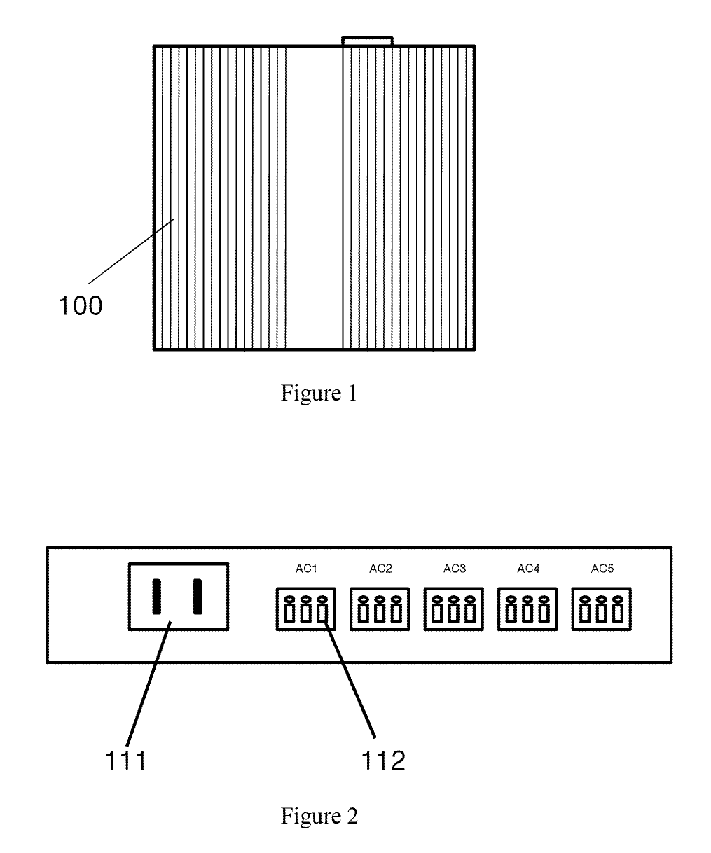

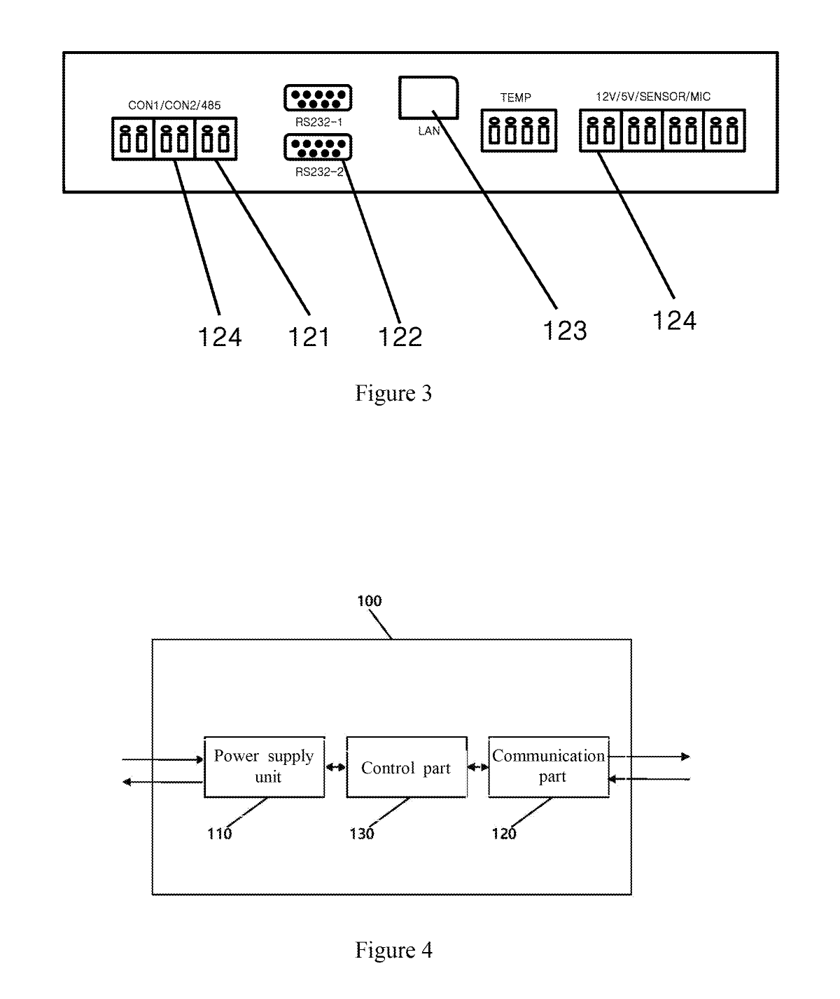

As illustrated in FIGS. 1 to 4, the mini remote multi control unit (100) in a preferred embodiment of this invention comprises a power supply unit (110), a communication part (120), and a control part (130).

The power supply unit (110) receives power from an outside source, features more than one power terminal block (112) and produces power to more than one controlled device connected to any of the power terminal blocks (112). The power supply unit (110) also features a power supply input terminal (111).

The communication part (120) transmits and receives power control data to power on/off controlled devices and the power terminal blocks (112).

The control part (130) selectively turns off any of the power terminal blocks (112) on the power supply unit (110) and then turns it back on to reset a controlled device if the controlled device is deemed as malfunctioning, using power control data being transmitted from the communication part (120). Ideally, the control part (130) should be controlled so that a power terminal block (112) can be turned off and then turned back on after a period of time.

Meanwhile, applicable controlled devices are any and all camera equipment used for surveillance or enforcement purposes, as well as personal and industrial purposes, and they can include a camera (20) that takes images, a computer (30) that receives and stores image data from the camera (20) and performs control operations, and a router (40) that transmits and receives data between the communication part (120), the camera (20), the computer (30), and an outside control room (50). Also, an electronic box (10) is also used to accommodate the camera (20), the computer (30), the router (40), and the mini remote multi control unit (100).

According to the aforementioned structure, in a preferred embodiment of this invention, the communication part (120) takes the amount of image data traffic generated by the camera (20) and transmitted to the computer (30) as primary power control data; the control part (130) determines the camera (20) is malfunctioning through traffic analysis if the volume of traffic falls below the pre-set traffic threshold, and gives an order that the power terminal block (112) connected to the camera (20) be turned off and then back on; and the power supply unit (110) selectively turns off the power terminal block (112) connected to the camera (20) and turns it back on, resetting the camera (20).

In addition, in another preferred embodiment of this invention, the communication part (120) takes the color value of image data generated by the camera (20) and transmitted to the computer (30) as secondary power control data; the control part (130) determines the camera (20) is malfunctioning through image analysis if a single color value continues over a period of time, and gives an order that the power terminal block (112) connected to the camera (20) be turned off and then back on; and the power supply unit (110) selectively turns off the power terminal block (112) connected to the camera (20) and turns it back on, resetting the camera (20); ideally, the period of time should be one to five minutes.

Furthermore, in another preferred embodiment of this invention, the communication part (120), when connected to the computer (30) via serial communication, takes serial data regularly transmitted and retrieved as third power control data; the control part (130) determines the computer (30) is malfunctioning through serial data analysis if serial data fails to be retrieved a certain consecutive number of times, and gives an order that the power terminal block (112) connected to the computer (30) be turned off and then back on; and the power supply unit (110) selectively turns off the power terminal block (112) connected to the computer (30) and turns it back on, resetting the computer (30); ideally, the frequency should be one to five seconds, and the number of times should be 40 to 80.

Moreover, in another preferred embodiment of this invention, the communication part (120) takes data retrieved from a ping test as fourth power control data after the ping test is performed using the router (40); the control part (130) determines the router (40) is malfunctioning through ping test analysis if ping test result data is not equal to the pre-set normal packet value, and gives an order that the power terminal block (112) connected to the router (40) be turned off and then back on; and the power supply unit (110) selectively turns off the power terminal block (112) connected to the router (40) and turns it back on, resetting the router (40).

In addition, in a preferred embodiment of this invention, if any of the controlled devices is deemed as malfunctioning more than N times straight, the control part (130) can stop the power on/off control of a power terminal block (112) at the (N+1)th time, and send an error alarm signal to the control room (50) via the communication part (120). Ideally, the number of times should be three to five. Furthermore, if the router is malfunctioning, it makes it difficult to communicate data to the control room (50). Ideally, separate wireless data communication modules, for instance, LTE modules, should be installed on the inside and outside of the mini remote multi-control unit.

Moreover, in a preferred embodiment of this invention, the control part (130) detects the amount of power from each of the power terminal blocks (112) in real-time, and sends an overload alarm signal to the control room (50) via the communication part (120) if the amount of power exceeds and remains above the pre-set overload threshold for a certain period of time.

Additionally, the communication part (120) of this invention can include a long-distance communication port (121) allowing communication with the camera (20), a short-distance communication port (122) for communication with the computer (30), an LAN port (123) for communication with the router (40), and a sensor port (124) for receiving signals from outside sensors.

In this embodiment, while relaying communication between controlled devices (20, 30, 40, and 50), the communication part (120) bypasses data transmission between the long-distance (121) and short-distance communication ports (122) to relay communication between the camera (20) and the computer (30), and connects the sensor port (124) to the short-distance communication port (122) to send a detection signal to the computer (30).

In another preferred embodiment of this invention, the mini remote multi-control unit (100) can further include a temperature sensor part that detects the internal temperature, and the communication part (120) can send a temperature sensor signal from the temperature sensor part to the computer (30) through the short-distance communication port (122).

According to a preferred embodiment of the invention, the mini remote multi-control unit can control the power supplies of devices from a distance, in order to prevent maintenance/repair costs caused by using manpower, since the malfunctioning of devices at industrial sites is usually solved by turning off their power switches, or by resetting the devices.

According to another preferred embodiment of the invention, the mini remote multi-control unit can accurately analyze the presence of malfunction, while controlling the power of a camera, computer and router in an electronic box where controlled devices, particularly surveillance or enforcement camera systems, are installed, and can also quickly issue alarms to a control room when recurring malfunctions occur in controlled devices. Also, in a preferred embodiment of the invention, the mini remote multi-control unit can relay communication between controlled devices to facilitate data communication between controlled devices.

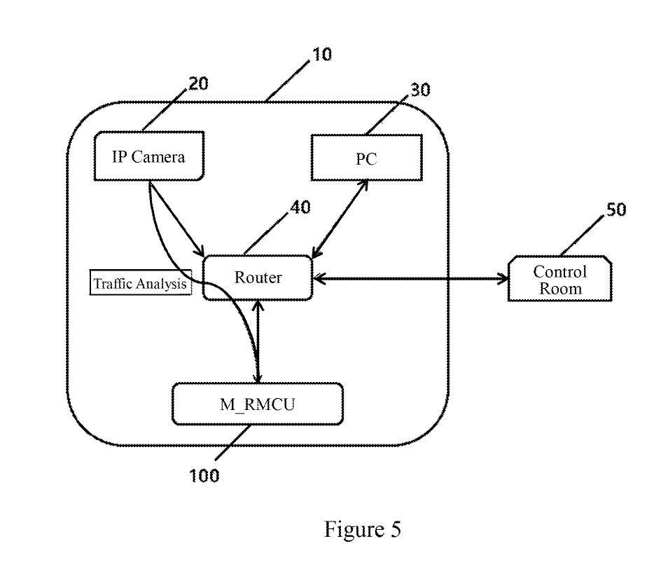

Through FIGS. 5 to 9, the following is the detailed description of the operational characteristics of the mini remote multi-control unit in a preferred embodiment of the invention.

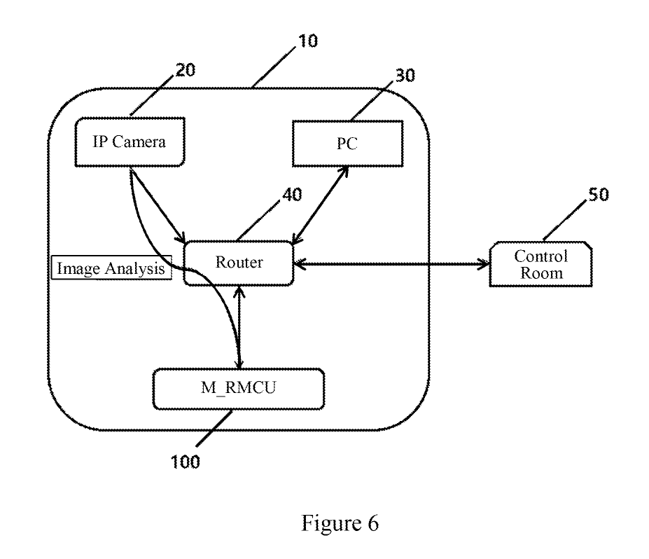

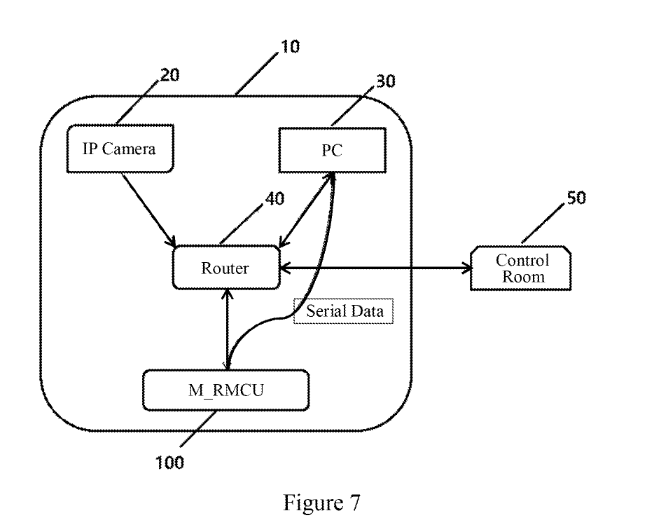

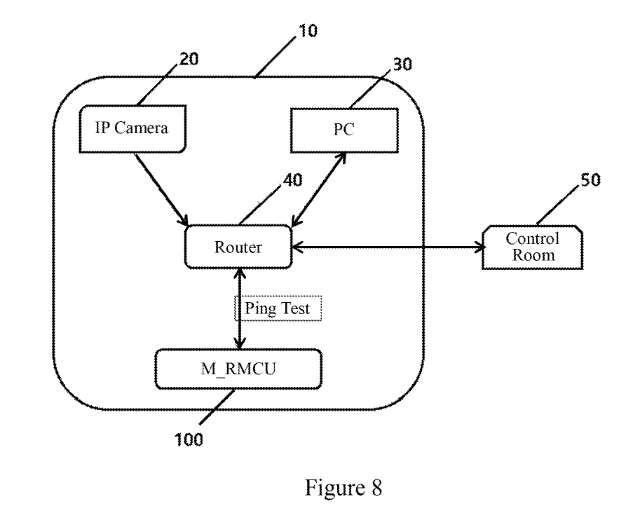

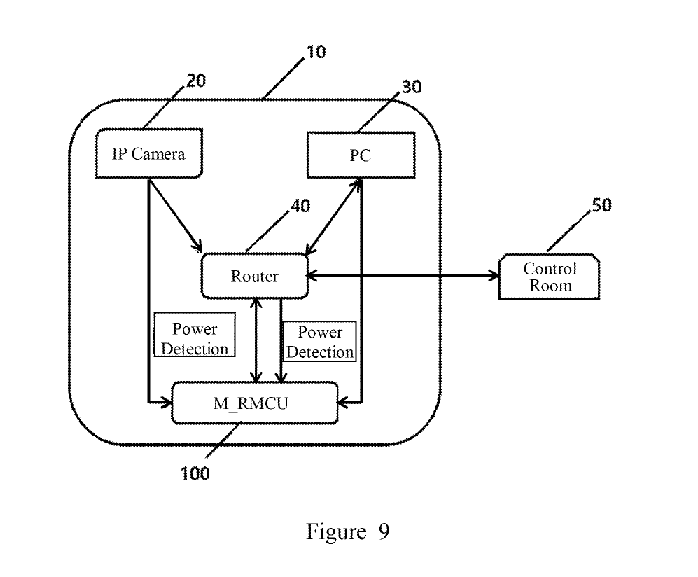

FIG. 5 is a drawing for operating a camera through traffic analysis of the mini remote multi control unit in a preferred embodiment of the invention; FIG. 6 is a drawing for controlling a camera through image analysis of the mini remote multi control unit in a preferred embodiment of the invention; FIG. 7 is a drawing for operating a computer through serial data analysis of the mini remote multi control unit in a preferred embodiment of the invention; FIG. 8 is a drawing for controlling a computer through ping test analysis of the mini remote multi control unit in a preferred embodiment of the invention; and FIG. 9 is a drawing that illustrates the overload detecting operation of the mini remote multi control unit in a preferred embodiment of the invention.

First of all, according to the installation process of the mini remote multi control unit, the power supply unit supplies power to the mini remote multi control unit when the power cord is connected to the power input terminal. Then, the cords that require power control are connected to the power terminal blocks.

In the communication part, the short-distance communication port is configured as RS232 connection and receives data controlling AC power from the computer. It can also measure the current temperature. The long-distance communication port is configured as R2485 connection and bypasses data received via RS232 communication and sends it to the camera.

In addition, the sensor port can receive contact signals from sensors like a dry contact sensor. When a contact signal is received, the port sends specified data to the computer via RS232 communication. For example, a loop detector can be used as a contact sensor to detect any passing vehicle. When the loop detector is connected to the sensor port, it sends the “L” character to the computer through RS232 communication. The LAN port receives data controlling AC power from the router.

FIG. 5 represents an example of using an IP camera, and the following steps can be taken to determine whether the camera is malfunctioning. First, send image data to a server to store an image taken with an IP camera. Since the camera incessantly transmits image data, it always causes more than a certain volume of traffic. In the case of HD images, three to four megabytes of data are stored every second.

If traffic from the IP camera falls below a certain level, it means that images are not being properly transmitted. When a traffic analysis is conducted by monitoring traffic from the IP camera through the mini remote multi control unit, if a traffic decrease is detected for a certain time (about 5 minutes), then the IP camera will be deemed as malfunctioning. Then turn the IP camera off and back on using the mini remote multi control unit.

FIG. 6 shows another way to determine whether the camera is malfunctioning, because traffic analysis alone is not sufficient to test malfunctioning IP cameras. For instance, even though the transmitting part of the camera sends a certain amount of data, if there is a problem with the image-taking part, e.g., an external issue with the lens, traffic analysis alone is not enough and an image analysis of the IP camera is required.

Therefore, even if the IP camera is functioning properly, an image may not be properly displayed due to a problem with the lens, or any other external factor. In this case, most images sent from the IP camera consist of a single color.

During an analysis of IP camera images through the mini remote multi control unit, if the aforementioned phenomenon is detected over a certain period of time, the IP camera is deemed as malfunctioning and it can be turned off and turned back on using the mini remote multi control unit.

When the malfunctioning of a camera is determined through traffic and image analyses, if the aforementioned abnormal event recurs more than three times, an error alarm is issued to the control room, and the control room stops power control temporarily until special measures are prepared. In other words, the invention can help solve fundamental problems with malfunctioning by both preventing damage to the camera caused by repeated power on/off and by informing the control room of relevant details.

According to FIG. 7, the mini remote multi control unit and a computer are connected by serial communication (RS232) to detect whether the computer is functioning. Whether the computer is functioning properly can be tested by communicating regularly (every second) between the mini remote multi control unit and the computer through certain data. While certain data is being transmitted, if there is no data returning from the computer 60 times straight, the computer is deemed as malfunctioning, and it can be turned off and then back on.

While the computer is being tested through serial data transmission, if the aforementioned event recurs over three consecutive times, an error alarm is issued to the control room and the control room stops power control temporarily until special measures are prepared. In other words, the invention can help solve fundamental problems with malfunctioning by both preventing damage to the camera caused by repeated power on/off and by informing the control room of relevant details.

According to FIG. 7, the mini remote multi control unit performs a ping test on the router and receives returning result value to determine whether the router is functioning. The ping test result shows that returning data is not a normal packet value or no reply, the router is deemed as malfunctioning, and it can be turned off and then back on.

Meanwhile, while the router is being tested, if the aforementioned event recurs over three consecutive times, an error alarm is issued to the control room and the control room stops power control temporarily until special measures are prepared. Since the router is designed to communicate data to the control room, the malfunctioning router may not send an alarm to the control room. Therefore, a separate LTE module should be installed on the mini remote multi control unit to issue an alarm to the control room.

FIG. 9 represents how to measure the power of controlled devices and detect overloads. The wattage of the loads of controlled devices included in the mini remote multi control unit is detected in real-time, sending the data.

While measuring the wattage, if an overload on a certain port is detected over a certain period of time (1 minute), the load is deemed as abnormal and an alarm is issued to the control room.

### Another Preferred Embodiment

In another preferred embodiment of the invention, the mini remote multi control unit can be used in booting stations for water supply systems. More specifically, the unit enables automatic recovery from communication errors (problems with routers and current IPs) between a control program installed in a central control center and PLC and electrical panels in unmanned boosting stations. In other words, a router can be reset using a router error watchdog feature.

In addition, if water fills a pump in a boosting station, a timer feature can be used to turn off the pump to prevent pump failure. In other words, if water enters the pump, the pump can be turned off and then re-energized after a period of time to reduce pump failure.

Furthermore, temperature measurement data can be sent to a situation room in a boosting station and a control room. Temperature and humidity can be checked from a distance, and fan coolers can be connected to contact points so that fans begin to operate at a certain temperature, reducing energy use.

Moreover, if the distance between the situation-room computer and the boosting station is less than 1 km, the computer can be tested using protocol data and the data can be sent to the control room. When a contact point is given to a water level detector, it can perform detection.

It will become apparent to those having ordinary skill in the art that the aforementioned technology of this invention can be carried out in other embodiments without modifying the technical idea or essential features of this invention.

Therefore, it should be understood that the embodiments described herein are only examples in all aspects and the invention is not limited to those described above, and all modifications and variations of the claims, their scope, and their equivalent concepts should be interpreted as being included in the scope of this invention.

### DESCRIPTION OF SIGNS

10: Electronic box
20: Camera
30: Computer
40: Router
50: Control room
100: Mini remote multi-control unit
110: Power supply unit
111: Power input terminal
112: Power terminal block
120: Communication part
121: Long-distance communication port
122: Short-distance connection port
123: LAN port
124: Sensor port
130: Control part

What is claimed is:

1. A mini remote multi-control unit comprising:
a power supply unit receiving power from an outside source and comprising a plurality of power terminal blocks and producing power to a plurality of controlled devices connected to any of the power terminal blocks;
a communication part transmitting and receiving power control data to power on/off the controlled devices and the power terminal blocks;
a control part selectively turning off any of the power terminal blocks on the power supply unit and then turns it back on to reset the controlled device if the controlled device is deemed as malfunctioning by using the power control data transmitted from the communication part.

2. The mini remote multi-control unit of claim 1,
wherein the control part gives an order that any of the power terminal blocks is turned off and then turned back on after a certain period of time.

3. The mini remote multi-control unit of claim 1,
wherein the controlled devices comprise:
a camera taking images and generating image data,
a computer receiving and storing the image data from the camera and performing control operations, and
a router transmitting and receiving data between the communication part, the camera, the computer, and an outside control room.

4. The mini remote multi-control unit of claim 3,
wherein the communication part takes an amount of image data traffic generated by the camera and transmitted to the computer as primary power control data;
while the control part determines the camera is malfunctioning through traffic analysis if the volume of traffic falls below a pre-set traffic threshold, the control part gives an order that the power terminal block connected to the camera is turned off and then back on
and the power supply unit selectively turns off the power terminal block connected to the camera and turns it back on to reset the camera.

5. The mini remote multi-control unit of claim 3,
wherein the communication part takes a color value of image data generated by the camera and transmitted to the computer as secondary power control data,
while the control part determines the camera is malfunctioning through image analysis if a single color value continues over a period of time, the control part gives an order that the power terminal block connected to the camera be turned off and then back on;
and the power supply unit selectively turns off the power terminal block connected to the camera and turns it back on to reset the camera.
